(19) United States
(12) Patent Application Publication
(10) Pub. No.: US 2009/0054052 A1
(43) Pub. Date: Feb. 26, 2009

(54) Remotely controlled traffic beacon

(76) Inventor: Andrew Blair Evans, Victoria (CA)

Correspondence Address: Andrew Evans;J.S. Foster Corporation, 6771 Kirkpatrick Crescent, Saanichton, BC, V8M 1Z8, CA

(21) Appl. No.: 11/894,198

(22) Filed: Aug. 21, 2007

(51) Int. Cl. H04M 3/00

(52) U.S. Cl. 455/420

(57) ABSTRACT

The invention provides an improved remotely controlled, solar-powered traffic beacon. Remote control is provided by a communications system that utilizes a cellular telephone modem and public cellular telephone networks to receive a schedule of activation/deactivation times or alternatively to receive immediate on/off commands. Furthermore, the communications system allows for the transmission of operational feedback data from the solar-powered traffic beacon to the user. The invention allows for remote control of solar-powered traffic beacons.

The remotely controlled, solar-powered traffic beacon comprises at least one traffic beacon including a lamp to warn traffic, solar panels to recharge batteries, batteries to store and supply power, communications circuitry containing a cellular telephone modem and software to receive the remote instructions and operational circuitry and software to manage the operation of all components.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM

Not applicable

### BACKGROUND OF THE INVENTION

This invention pertains to traffic beacons. More specifically this invention pertains to solar-powered traffic beacons containing a communications technology that enables the beacons to be remotely controlled.

Remote controlled solar-powered traffic beacons are commonly installed by government agencies along roadways to alert motorists to intermittent road safety conditions. The beacons may be activated according to a daily schedule, such as when children are traveling to and from school, or the beacons may be activated during urgent traffic situations, such as emergency road closures. Although they have achieved popularity and commercial success, there has been a continuing need for improvement, particularly with regards to the geographic range of operation, the promptness of the communications signal reaching the beacon and the requirement to transmit operational feedback information to the user. Generally speaking, conventional devices make use of either public pager networks which are limited in range to major cities, or private radio broadcasts which necessitate the building of private radio towers positioned to transmit radio signals to the beacons. Within the beacon, the circuitry involved in these technologies has relatively large power consumption, thus necessitating either a larger than desired solar power plant or only an intermittent activation cycle. Furthermore, neither of these technologies contains the ability to transmit operational feedback information to the user over a long distance.

### BRIEF SUMMARY OF THE INVENTION

The invention provides an improved remotely controlled solar-powered traffic beacons. Remote control is provided by a communications system that utilizes a cellular telephone modem, positioned inside the beacon, to receive a schedule of activation/deactivation or alternatively to receive immediate on/off commands. Furthermore, the communications system allows for the transmission of operational feedback data from the solar-powered traffic beacon to the user.

The invention possesses advantages over existing beacons. The invention utilizes a cellular telephone modem and public cellular telephone networks for communications between the user and the beacon. Thus it enables the beacon to be installed in wider geographic regions without the installation of additional communications infrastructure. The invention therefore increases the geographic range of installation and reduces installation cost. In addition, because cellular-telephone modems use relatively less electrical energy than conventional communication system hardware, the communications system can remain active 24-hours a day, thus allowing for immediate communications and activation/deactivation of the solar-powered traffic beacon.

A practical example of the benefits possessed by the invention resides in the ability to install the beacons, without modification and without additional communications infrastructure, anywhere in the world that can be reached by a cellular telephone signal. The present invention, given its use of a cellular telephone modem, is suited to take advantage of the wide geographic spread of public cellular telephone networks. Furthermore, the low power consumption requirement of a cellular telephone modem allows the communications system to be active 24-hours a day.

It can thus be seen that the present invention provides a novel and improved remotely controlled solar powered traffic beacons.

The remotely controlled, solar-powered traffic beacon comprises at least one traffic beacon including a lamp to warn traffic, solar panels to recharge batteries, batteries to store and supply power, communications circuitry containing a cellular telephone modem and software to receive the remote instructions and operational circuitry and software to manage the operation of all components.

Within the communications circuitry, the cellular telephone modem receives preformatted signals transmitted via public cellular telephone networks. Such preformatted signals originate from a text-message sent from a cellular telephone, or alternatively originate from a textual message sent from the Internet via SMS gateway, or alternatively originate from a textual message sent from the Internet via file transfer, or alternatively originate from a binary file sent from the Internet via file transfer. Such signals contain a predefined schedule of activation/deactivation for the beacon. Alternatively, such signals contain immediate on/off commands for the beacon. The communications circuitry transmits on/off commands by wire or alternatively by radio signal to the operational circuitry in the beacon. The operational circuitry contains the on/off controls of the lamp as well as energy management system for the solar panels and batteries. Alternatively, the communications circuitry sends on/off commands by radio signal to operational circuitry positioned within other beacons located within a range of 1 kilometer. Furthermore, the communications circuitry transmits, by use of the cellular telephone modem, operational feedback information on the condition of the solar-powered traffic beacon to the user.

The communications circuitry is affixed with two antennae. One of these antennas is connected to the cellular telephone modem and is used to receive/transmit the cellular telephone signal. The other antenna is connected to a radio transmitter and is used to transmit on/off commands to operational circuitry contained within that beacon and within other beacons located within a range or 1 kilometer.

The operational circuitry is affixed with one antenna. This antenna is connected to a radio receiver and is used to receive on/off commands from the communications circuitry.

Considered broadly, traffic beacons according to the invention consist of:
Solar panels used to derive electrical energy available from sunshine
Batteries used to store electrical energy and provide electrical energy to the beacon during periods when the sun is not visible.
Circuitry used to manage the electrical energy and operate the lamp.
Circuitry used to receive and manage remote activation messages.
A lamp meeting government and traffic industry requirements for colour and luminous intensity.
A lamp head meeting government and traffic industry requirements for construction.

### BRIEF DESCRIPTION OF THE SEVERAL VIEWS OF THE DRAWING

In the drawings, which form a part of this specification, FIGS. 1, 2 and 4 show a standard configuration for remotely activated single-head solar-powered traffic beacons:

FIG. 1: Single-head beacon, front view, showing the signal light sub-assembly and power plant sub-assembly.

FIG. 2: Single-head beacon, side view, showing the signal light sub-assembly and power plant sub-assembly.

FIG. 4: Single-head beacon, top view, showing the power plant sub-assembly.

With emphasis on the Power plant sub-assembly:

FIG. 3: Power plant sub-assembly, front view

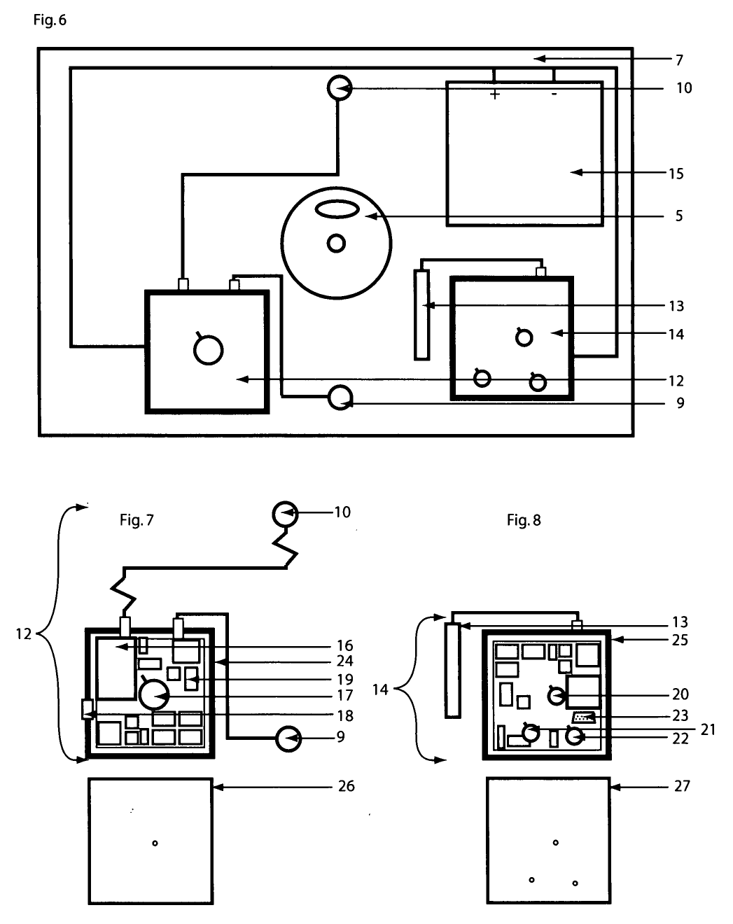

FIG. 4: Power plant sub-assembly, top view

FIG. 5: Power plant sub-assembly, side view

FIG. 6: Power plant sub-assembly, internal top view

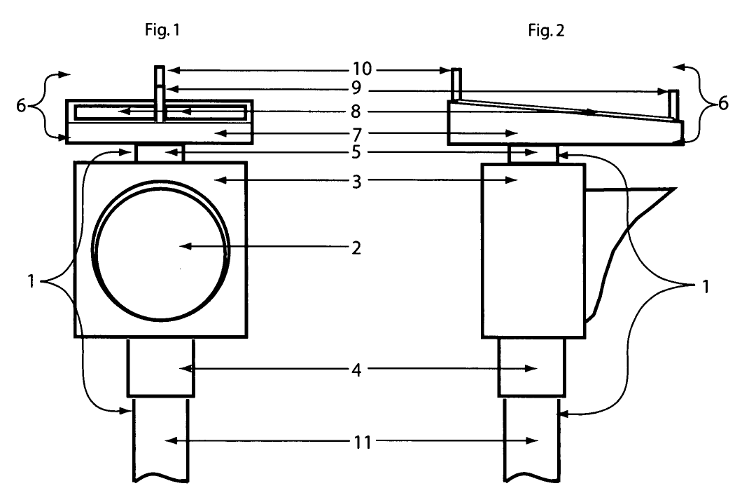

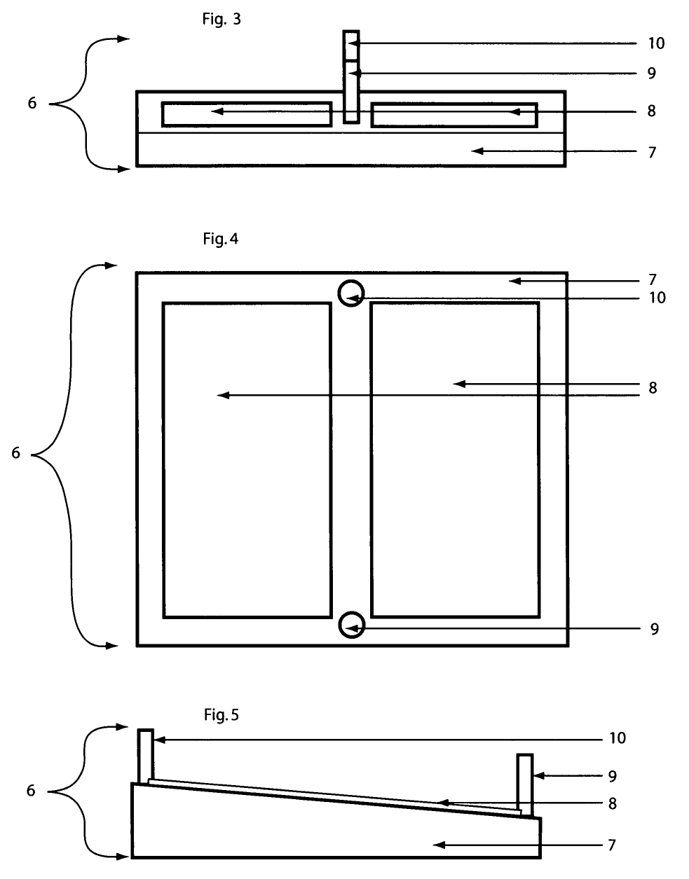

Within FIGS. 1 and 2 the following standard components are visible in the diagrams:
1. Signal light sub-assembly
2. Lamp
3. Lamp head with visor
4. Mounting collar
5. Connection collar
6. Power plant sub-assembly
7. Power plant housing
8. Solar panels
9. Communications circuitry radio antenna
10. Cellular telephone modem antenna
11. Pole

Within the power plant sub-assembly in FIGS. 3, 4 and 5, the following components are visible in the diagram:
7. Power plant housing
8. Solar panels
9. Communications circuitry radio antenna
10. Cellular telephone modem antenna

Within FIG. 6, the internal top view of the power plant sub-assembly, the following components are visible in the diagram:
5. Connection collar with bolt hole and wire hole
7. Power plant housing
9. Communications circuitry radio antenna
10. Cellular telephone modem antenna
12. Communications circuitry sub-assembly
13. Operational circuitry radio antenna
14. Operational circuitry sub-assembly
15. Battery pack

FIG. 7 illustrates the internal top view of the communications circuitry sub-assembly 12 including the circuit box 24 and various circuitry components as described within the detailed description of the invention.

FIG. 8 illustrates the internal top view of the operational circuitry sub-assembly 14 including the circuit box 25 and various circuitry components as described within the detailed description of the invention.

### DETAILED DESCRIPTION OF THE INVENTION

The invention provides an improved remotely controlled solar-powered traffic beacon. Remote control is provided by a communications system that utilizes a cellular telephone modem, positioned inside the beacon, to receive a schedule of activation/deactivation or alternatively to receive immediate on/off commands. Furthermore, the communications system allows for the transmission of operational feedback data from the solar-powered traffic beacon to the user.

FIGS. 1 and 2 and 4 illustrate the remotely controlled solar-powered traffic beacon according to the preferred embodiment. The principal components of the beacon are the signal light sub-assembly 1 and power plant sub-assembly 6.

As visible in FIGS. 1 and 2, the signal light sub-assembly 1, includes at least one lamp 2 mounted within a lamp head with visor 3 in a conventional manner, mounting collar 4 and connection collar 5, which are deployed on pole 11 by means of set-screws (not shown).

The power plant sub-assembly 6, as visible in FIGS. 1, 2, 3, 4 and 5, consists of the power plant box 7, a plurality of solar panels 8, communications circuitry radio antenna 9, and cellular telephone modem antenna 10.

The open power plant sub-assembly 6, is visible in FIG. 6, consisting of battery pack 15, communications circuitry sub-assembly 12, cellular telephone modem antenna 10, communications circuitry radio antenna 9, operational circuitry sub-assembly 14, and operational circuitry radio antenna 13. The power plant sub-assembly combines the functions of providing power to all components of the beacon, receiving operational commands from the communications circuitry sub-assembly, controlling the flashing, diagnostic and maintenance of all components of the beacon and effecting communication with companion beacons.

Power plant sub-assembly 6 and light head sub-assembly 1 are connected with a bolt (not shown) inserted through the bolt hole in connecting collar 5. Wires (not shown) between the operational circuitry 14 and lamp 2 are passed through the wire hole in the connecting collar 5.

Power plant sub-assembly 6 comprises a plurality of solar panels 8, mounted on top as shown in FIG. 4. The solar panels 8 are affixed to the power plant housing by means of glue. The solar panels 8 are used to derive electrical energy available from sunshine. Also mounted on top of power plant sub-assembly 6, by means of threaded connectors, are cellular telephone modem antenna 10, and communications circuitry radio antenna 9.

Mounted inside power plant sub-assembly 6 are a plurality of batteries contained within a battery pack 15, affixed to the housing by means of Velcro straps; communications circuitry sub-assembly 12 and operational circuitry sub-assembly 14 affixed by means of bolts; and operational circuitry radio antenna 13 affixed by means of a Velcro strap.

As illustrated in FIG. 7 of the communications circuitry sub-assembly 12, the open communications circuitry sub-assembly box 24 with lid 26, contains a cellular telephone modem 16 along with a real-time clock 19, and the circuitry and software required to receive, store, manage and transmit on/off commands to the operational circuitry sub-assembly 14. Communications circuitry sub-assembly 12 contains a single control dial 17 with settings for run; training; reset; test; diagnostics. The run setting is used for normal operation of the beacon. The training setting is used to send a training command to the operational circuitry sub-assembly such that the operational circuitry sub-assembly will only respond to on/off commands transmitted from the desired communications circuitry sub-assembly, and not from another system located within radio range of 1 kilometer. The reset setting is used to reset the communications system. The test setting is used to send short on/off commands to the operational circuitry sub-assembly, ensuring that it will respond properly to the communications circuitry sub-assembly. The diagnostic setting is used to diagnose the operation of the communications circuitry sub-assembly by connecting a properly formatted computer via the serial port 18.

As illustrated in FIG. 8 of the operational circuitry sub-assembly 14, the open operational circuitry sub-assembly box 25 with lid 27, contains all of the circuitry and software required for local operation of the beacon, including monitoring and managing the energy derived from the solar panels 8, managing the charging of the batteries 15, providing power to the communications circuitry sub-assembly 12, the receipt of on/off commands through the operational circuitry sub-assembly radio antenna 13 transmitted from the communications circuitry sub-assembly 9, receipt of programming instructions through serial port connector 23, and controlling the lamp 2 illumination cycle. The operational circuitry sub-assembly contains three control dials: Control dial 20 has a setting to receive training commands from the communications circuitry and a run setting for normal operation of the beacon. Control dial 21 contains a series of network addresses, such that beacons positioned in proximity closer than 300 meters will/will not communicate with each other as desired. Control dial 22 contains setting for individual lamp illumination and flash patterns, as well as a system reset function.

In operation, a text message on/off command sent from the operator's cellular telephone is received by the cellular telephone modem antenna 9 and cellular telephone modem 16. The command is managed by the communications circuitry sub-assembly 12 and transmitted through the communications circuitry radio antenna 9 to the operational circuitry radio antenna 13 and operational circuitry sub-assembly 14. The operational circuitry sub-assembly manages the command, resulting in the lamp being activated/deactivated as desired.

Alternatively, a long term activation schedule for the beacon, sent by a textual message from the Internet via SMS gateway, or alternatively sent by a textual message from the Internet via file transfer, or alternatively sent by a binary file from the Internet via file transfer, is received by the cellular telephone modem antenna 9 and cellular telephone modem 16. The schedule is stored and managed within the communications circuitry sub-assembly making use of the real-time clock 19. As scheduled, on/off commands are transmitted through the communications circuitry radio antenna 9 to the operational circuitry sub-assembly 14, resulting in the lamp being activated/deactivated as scheduled.

The preferred embodiment of the invention has been described in some detail but the reader is reminded that this is the preferred embodiment only. Variations and modifications thereto may be implemented without thereby departing from the scope of the invention, which is more particularly defined by the following claims.

The embodiments of the invention in which an exclusive property or privilege is claimed are defined as follows:

1. A traffic beacon assembly comprising: a traffic signal lamp; batteries; solar panels; an operational system; a communications system.

2. The traffic beacon assembly of claim 1 wherein said solar panels provide electrical energy to charge said batteries.

3. The traffic beacon assembly of claim 1 wherein said operational system manages the charging of said batteries from the output of said solar panels.

4. The traffic beacon assembly of claim 1 wherein said operational system, said communications system and said lamp are powered by said batteries.

5. The traffic beacon assembly of claim 1 wherein said operational system provides power management based on available solar and battery power to said lamp, said communications system and said operational system.

6. The traffic beacon assembly of claim 1 comprising operational software for coordinating said operational system.

7. The traffic beacon assembly of claim 1 wherein said operational system includes a means to receive on and off commands transmitted from said communication system by means of radio signal or by wire.

8. The traffic beacon assembly of claim 1 wherein said communication system comprises a cellular telephone modem.

9. The traffic beacon assembly of claim 1 wherein said cellular telephone modem of claim 8 comprises a means to receive instructions remotely transmitted via public cellular telephone networks.

10. The traffic beacon assembly of claim 1 wherein said means to receive instructions of claim 9 comprises means to receive instructions originating from a text-message sent from the operator's cellular telephone.

11. The traffic beacon assembly of claim 1 wherein said means to receive instructions of claim 9 comprises means to receive instructions originating from a textual message sent from the Internet via SMS gateway.

12. The traffic beacon assembly of claim 1 wherein said means to receive instructions of claim 9 comprises means to receive instructions originating from a textual message sent from the Internet via file transfer.

13. The traffic beacon assembly of claim 1 wherein said communication system and said cellular telephone modem of claim 8 are functioning at all times.

14. The traffic beacon assembly of claim 1 wherein said communications system and said cellular telephone modem of claim 8 are functioning periodically when so directed by the operational system of claim 5.

15. The traffic beacon assembly of claim 1 wherein said communication system includes a means to transmit on and off commands to said operational system by means of radio signal or alternatively by wire.

16. The traffic beacon assembly of claim 1 comprising communication software to coordinate the receipt of remotely transmitted instructions of claim 9 and the transmission of on and off commands to said operational system of claim 7.

17. The traffic beacon assembly of claim 1 wherein said communications system comprises a means to transmit, by means of said cellular telephone modem of claim 8, system feedback information to the operator via public cellular telephone networks.

18. The traffic beacon assembly of claim 1 wherein said communications system comprises a means to directly connect a computer for programming and diagnostic purposes.

19. The traffic beacon assembly of claim 1 wherein said operational system comprises a means to directly connect a computer for programming and diagnostic purposes.

20. The traffic beacon assembly of claim 1 comprises housings for said traffic signal lamp, solar panels, operational system and communications system.
